(19) United States
(12) Patent Application Publication
(10) Pub. No.: US 2025/0335242 A1
(43) Pub. Date: Oct. 30, 2025

(54) COMPUTER-READABLE RECORDING MEDIUM STORING SCHEDULING PROGRAM, INFORMATION PROCESSING DEVICE, AND SCHEDULING METHOD

(71) Applicant: Fujitsu Limited, Kawasaki-shi (JP)

(72) Inventor: Yoshifumi UJIBASHI, Kawasaki (JP)

(73) Assignee: Fujitsu Limited, Kawasaki-shi (JP)

(21) Appl. No.: 19/050,559

(22) Filed: Feb. 11, 2025

(30) Foreign Application Priority Data
Apr. 26, 2024 (JP) 2024-072697

(51) Int. Cl. G06F 9/48; G06F 9/50

(52) U.S. Cl. CPC G06F 9/4881; G06F 9/5027; G06F 2209/5021

(57) ABSTRACT

A non-transitory computer-readable recording medium stores a scheduling program for causing a computer to execute processing including: predicting an acceleration rate that accompanies with execution of a deep learning model, with reference to an execution history of a program in which a type, a batch size, and an acceleration rate of the deep learning model are associated, based on information regarding a job to be processed for the deep learning model; and determining an order of a program that allocates a calculation resource, based on a prediction result of the acceleration rate.

### CROSS-REFERENCE TO RELATED APPLICATION

This application is based upon and claims the benefit of priority of the prior Japanese Patent Application No. 2024-72697, filed on Apr. 26, 2024, the entire contents of which are incorporated herein by reference.

### FIELD

The embodiment discussed herein is related to a scheduling program, an information processing device, and a scheduling method.

### BACKGROUND

It has been known that a processing performance is improved by using a graphics processing unit (GPU), instead of a central processing unit (CPU), to execute a deep learning application (hereinafter, referred to as deep learning application). In recent years, it can be said that the GPU is essential for execution of the deep learning application.

Japanese National Publication of International Patent Application No. 2022-515302 is disclosed as related art.

### SUMMARY

According to an aspect of the embodiments, a non-transitory computer-readable recording medium stores a scheduling program for causing a computer to execute processing including: predicting an acceleration rate that accompanies with execution of a deep learning model, with reference to an execution history of a program in which a type, a batch size, and an acceleration rate of the deep learning model are associated, based on information regarding a job to be processed for the deep learning model; and determining an order of a program that allocates a calculation resource, based on a prediction result of the acceleration rate.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram schematically illustrating a configuration of a scheduling system according to an embodiment;

FIG. 2 is a block diagram illustrating a hardware (HW) configuration example of a computer that implements functions of the scheduling system according to the embodiment;

FIG. 3 is an image diagram illustrating a relationship between a batch size and an acceleration rate regarding processing of a deep learning program;

FIG. 4 is a diagram illustrating job execution history information in the scheduling system according to the embodiment;

FIG. 5 is a diagram for explaining a method for verifying a predicted acceleration rate range determined by an acceleration rate prediction unit of the scheduling system according to the embodiment;

FIG. 6 is a diagram for explaining processing of a calculation resource scheduling unit 103 of the scheduling system according to the embodiment;

FIG. 7 is a flowchart for explaining training processing of a deep learning model in the scheduling system according to the embodiment; and

FIG. 8 is a flowchart for explaining details of processing in step S3 in the flowchart illustrated in FIG. 7.

### DESCRIPTION OF EMBODIMENTS

Since a unit price of the GPU is higher than that of the CPU, it is important to successfully share and use a small number of GPUs between a plurality of processes.

In a known job scheduler such as Slurm, since the GPU continues to be occupied from process execution start to end, it is not possible to simultaneously execute the jobs more than the number of GPUs. A job for which the GPU cannot be secured is input into a job queue and stands by until a process using the GPU is completely ended. Alternatively, a CPU having a poorer processing performance than the GPU is caused to process the job.

Furthermore, as a method for efficiently using the GPU, GPU preemption has been known. In the GPU preemption, a job that is using the GPU is stopped from outside, and it is possible to transfer the right of use of the GPU to another job. By periodically performing such GPU preemption, it is possible to switch a GPU utilization process in time units, and a subsequent job can use the GPU without waiting for complete stop of a prior job.

It is desired to reduce cost of switching between a CPU and a GPU and execution time cost and efficiently process a process.

In one aspect, an object of the embodiment is to enable to efficiently allocate a GPU to a process.

Hereinafter, an embodiment of a scheduling program, an information processing device, and a scheduling method will be described with reference to the drawings. Note that the embodiment to be described below is merely an example, and there is no intention to exclude application of various modifications and techniques not explicitly described in the embodiment. For example, the present embodiment may be variously modified and implemented in a range that does not depart from the spirit thereof. Furthermore, each drawing is not intended to include only components illustrated in the drawings, and may include another function and the like.

### (A) Related Art

When allocation of GPUs to a plurality of programs is scheduled, it is effective to determine to which program the GPU is allocated so as to accelerate training processing and determine a priority of the allocation of the GPUs.

A ratio (execution time ratio) between an execution time in a case where processing is executed using a CPU and an execution time in a case where the same processing is executed using a GPU may be referred to as an acceleration rate.

A method is considered for improving a utilization rate of the GPU that is a resource, by allocating the GPU to a program that accelerates GPU execution as compared with CPU execution as possible. In order to realize such a method, it is effective to cause each GPU to execute dummy processing from each program, before execution of each program and measure a GPU performance based on execution results of these dummy processing. The dummy processing may be referred to as a dummy job. Furthermore, execution of the dummy processing may be referred to as dummy execution. The program may be a deep learning processing program.

It is desirable to execute several steps of the dummy execution, immediately before training processing start of a deep learning program main body, so as not to affect processing of the deep learning program main body as possible. Furthermore, in order to quickly switch the allocation of the GPUs to the programs, it is necessary to set a high priority to the dummy execution, in job scheduling.

Based on the execution result of such a dummy job, an execution time of the training processing of the deep learning program main body is estimated.

Each of the CPU and the GPU is caused to perform the dummy execution, and a training processing execution time on the CPU and a training processing execution time on the GPU are actually measured. Then, a ratio (execution time ratio and acceleration rate) between an execution time in a case where processing is executed using the CPU and an execution time in a case where the same processing is executed using the GPU is calculated, and the GPU is allocated to a program with a high acceleration rate.

However, since processing executed in the dummy execution is not essential processing in the execution of the deep learning program, execution time cost is generated. Therefore, it is desirable to reduce the number of dummy executions as possible.

Furthermore, the high priority of the dummy execution deprives a GPU used by another program, for performance measurement. Moreover, as a result of the performance measurement, in a case where an acceleration rate of the program from which the GPU is deprived by the dummy execution is high, it is necessary to return the GPU to the deprived program. In such a case, useless GPU switching occurs as a result. For example, cost for switching the CPU/GPU is generated for the dummy execution. Therefore, from such a viewpoint, it is desirable to reduce the number of dummy executions.

One object of a scheduling system 1 according to an example of an embodiment is to enable to reduce the number of dummy executions.

### (B) Configuration

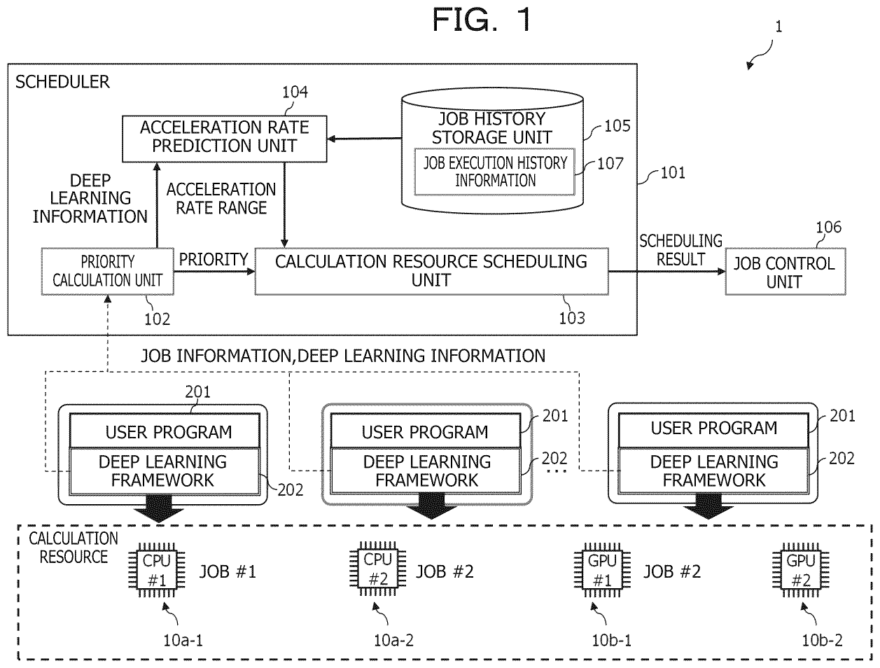

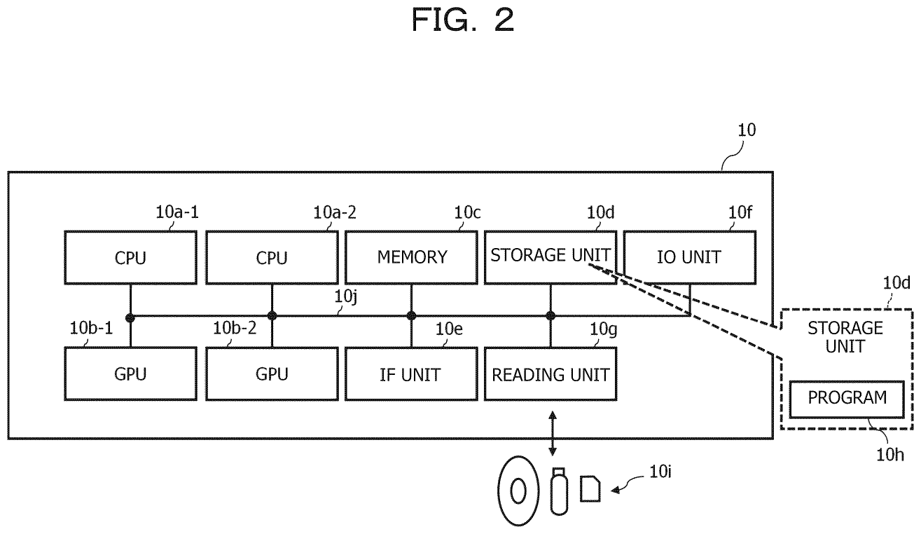

FIG. 1 is a diagram schematically illustrating a configuration of the scheduling system 1 according to the embodiment, and FIG. 2 is a block diagram illustrating a hardware (HW) configuration example of a computer 10 that implements functions of the scheduling system 1 according to the embodiment.

### (B-1) Hardware Configuration Example

In a case where a plurality of computers is used as a HW resource for implementing the functions of the scheduling system 1, each computer may have the HW configuration illustrated in FIG. 2.

As illustrated in FIG. 2, the computer 10 may illustratively include one or more (two in example illustrated in FIG. 2) CPUs 10a-1 and 10a-2, one or more (two in example illustrated in FIG. 2) GPUs 10b-1 and 10b-2, a memory 10c, a storage unit 10d, an interface (IF) unit 10e, an input/output (IO) unit 10f, and a reading unit 10g. Hereinafter, in a case where the CPUs 10a-1 and 10a-2 are not particularly distinguished from each other, the CPUs 10a-1 and 10a-2 are referred to as a CPU 10a. Furthermore, in a case where the GPUs 10b-1 and 10b-2 are not particularly distinguished from each other, the GPUs 10b-1 and 10b-2 are referred to as a GPU 10b.

The CPU 10a is an example of an arithmetic processing device that performs various types of control and operations, which is a control unit that performs various types of processing. The CPU 10a may be communicably coupled to each block in the computer 10 with a bus 10j. Note that the CPU 10a may be a multiprocessor including a plurality of processors, or a multi-core processor including a plurality of processor cores, or may have a configuration including a plurality of multi-core processors.

The GPU 10b performs screen display control on an output device such as a monitor in the IO unit 10f. Furthermore, the GPU 10b may have a configuration as an accelerator that executes machine learning processing and inference processing using a machine learning model.

These CPUs 10a-1 and 10a-2 and GPUs 10b-1 and 10b-2 are examples of a calculation resource.

The memory 10c is an example of HW that stores information such as various types of data and programs. As the memory 10c, for example, one or both of a volatile memory such as a dynamic random access memory (DRAM) and a nonvolatile memory such as a persistent memory (PM) are exemplified.

The storage unit 10d is an example of HW that stores information such as various types of data and programs. As the storage unit 10d, various storage devices such as a magnetic disk device such as a hard disk drive (HDD), a semiconductor drive device such as a solid state drive (SSD), or a nonvolatile memory are exemplified. As the nonvolatile memory, for example, a flash memory, a storage class memory (SCM), a read only memory (ROM), and the like are exemplified.

The storage unit 10d may store a program 10h (scheduling program) that implements all or a part of various functions of the computer 10.

For example, a processor 10a of the scheduling system 1 may implement a scheduling function to be described later, by developing and executing the program 10h stored in the storage unit 10d on the memory 10c. Furthermore, the storage unit 10d implements a function as a job history storage unit 105 illustrated in FIG. 1.

The IF unit 10e is an example of a communication IF that performs, for example, control of coupling and communication between the present computer 10 and another computer. For example, the IF unit 10e may include an adapter conforming to a local area network (LAN) such as Ethernet (registered trademark), optical communication such as a fibre channel (FC), or the like. The adapter may support one or both of wireless and wired communication schemes. Note that the program 10h may be downloaded from a network to the computer 10 via the communication IF and stored in the storage unit 10d.

The IO unit 10f may include one or both of an input device and an output device. As the input device, for example, a keyboard, a mouse, a touch panel, and the like are exemplified. As the output device, for example, a monitor, a projector, a printer, and the like are exemplified. Furthermore, the IO unit 10f may include a touch panel or the like in which the input device and the output device are integrated. The output device may be coupled to the GPU 10b.

The reading unit 10g is an example of a reader that reads information including data and programs recorded in a recording medium 10i. The reading unit 10g may include a coupling terminal or a device to which the recording medium 10i can be coupled or inserted. As the reading unit 10g, for example, an adapter conforming to a universal serial bus (USB) or the like, a drive device that accesses a recording disk, a card reader that accesses a flash memory such as a secure digital (SD) card, and the like are exemplified. Note that the program 10h may be stored in the recording medium 10i, and the reading unit 10g may read the program 10h from the recording medium 10i and store the read program 10h in the storage unit 10d.

As the recording medium 10i, for example, a non-transitory computer-readable recording medium such as a magnetic/optical disk or a flash memory is exemplified. As the magnetic/optical disk, for example, a flexible disk, a compact disc (CD), a digital versatile disc (DVD), a Blu-ray disc, a holographic versatile disc (HVD), and the like are exemplified. As the flash memory, for example, a semiconductor memory such as a USB memory or an SD card is exemplified.

The HW configuration of the computer 10 described above is an example. Therefore, an increase or decrease in the HW (for example, addition or deletion of optional block), division, integration in an optional combination, addition or deletion of the bus, or the like in the computer 10 may be appropriately performed.

### (B-2) Functional Configuration Example

As illustrated in FIG. 1, for example, the scheduling system 1 may have functions as a scheduler 101, an acceleration rate prediction unit 104, a job control unit 106, a user program 201, and a deep learning framework 202. Those functions may be implemented by the hardware of the computer 10 (see FIG. 2).

The user program 201 is a program that performs deep learning (training) of a deep learning model (machine learning model) (not illustrated) and executes a job related to deep learning, transmitted (allocated) from the job control unit 106 to be described later.

The user program 201 uses a library provided by each application programming interface (API), by calling the API of the deep learning framework 202 in deep learning model training processing. For example, the user program 201 calls the library using a fit( ) function or the like. Furthermore, to the calling (fit( ) function or the like) of the library provided by the API, a hook for acquiring the deep learning model and an object (deep learning model object and input tensor information) of input data is set in advance. An input tensor size, for example, a batch size may be included in the information regarding the input tensor.

Information including the deep learning model object and the input tensor size (batch size) may be referred to as deep learning information. The deep learning information is an example of information regarding a job to be processed.

Along with the allocation of the jobs, an instruction to activate the allocated job or information regarding the calculation resource (CPU 10a and GPU 10b) that executes the job are transmitted from the job control unit 106 to the user program 201.

Furthermore, in a case where a job being executed by the user program 201 is moved to another calculation resource, an instruction to stop the user program 201 and an instruction to reactivate the job in the calculation resource after the movement are input to the user program 201, from the job control unit 106.

In the scheduling system 1, scheduling is performed for allocating the calculation resource (GPU 10b) to each of the plurality of user programs 201 and executing the job.

A user program 201 to be a scheduling target, among the user program 201, may be referred to as a scheduling target user program 201.

Furthermore, for example, the user program 201 uses a high-level API such as Keras or Pytorch lightning, and it is assumed that a deep learning model to be trained be constructed by combining existing Layers (fully convolutional networks (FCN), convolutional neural network (CNN), long short-term memory (LSTM), Dropout, Pooling, or the like).

When receiving job information of the job to be executed from the job control unit 106 to be described later, the user program 201 processes the job via the deep learning framework 202. The user program 201 executes the training processing until an epoch ends.

The deep learning framework 202 is software that functions as a base of the user program 201 and included in correspondence with the user program 201. The user program 201 is executed on the deep learning framework 202. Therefore, the deep learning framework 202 may be included for each user program 201.

The deep learning framework 202 is software to be a base used to efficiently advance machine learning by the user program 201 and may include, for example, a processing pattern that is often used in the user program 201 or the like as a library.

The deep learning framework 202 may include a deep learning library, for example, the Keras, the Pytorch lighting, or the like described above. These deep learning libraries may function as the APIs, and the user program 201 uses the high-level API such as the Keras or the Pytorch lightning.

The deep learning framework 202 acquires the deep learning information (deep learning model object and input tensor), via the hook provided in advance to call the library provided by the API such as the fit( ) function. The deep learning framework 202 acquires a type and a batch size of the deep learning model, from the acquired object.

Furthermore, the deep learning framework 202 transmits the job information and the deep learning information to a priority calculation unit 102 to be described later.

For example, a job identification (ID) and a dummy job execution status may be included in the job information. The job ID is identification information used to identify a job. The dummy job execution status may include at least any one piece of information including CPU dummy job execution completion, a CPU epoch execution time, GPU dummy job execution completion, and a GPU epoch execution time.

The CPU dummy job execution completion is included in the job information in a case where one epoch of the dummy job is executed by the CPU 10a. Furthermore, the CPU epoch execution time is an execution time required in a case where one epoch of the dummy job is executed by the CPU 10a. The GPU dummy job execution completion is included in the job information in a case where the dummy job is executed by the GPU 10b. Furthermore, the GPU epoch execution time is an execution time required in a case where the dummy job is executed by the GPU 10b.

Moreover, the deep learning framework 202 records a job execution history by the user program 201 in job execution history information 107 of the job history storage unit 105.

When the training processing on the deep learning model by the user program 201 ends, the deep learning framework 202 notifies the scheduler 101 of resource information (GPU/CPU) transferred from the calculation resource scheduling unit 103.

Furthermore, the deep learning framework 202 transmits the job information and the deep learning information to the scheduler 101 (priority calculation unit 102).

The scheduler 101 allocates the calculation resources (CPUs 10a and 10b) to the user program 201.

Now, since an execution time ratio (acceleration rate) between a plurality of types of processors depends on a performance and a program of the calculation resource, the execution time ratio is basically unknown without execution. However, the applicant of the present application has found that the deep learning program has characteristics that the acceleration rate monotonically increases according to the batch size.

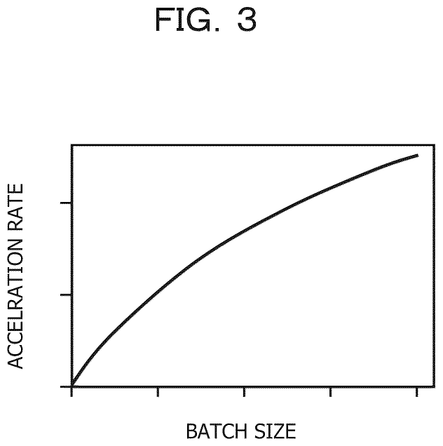

FIG. 3 is an image diagram illustrating a relationship between a batch size and an acceleration rate regarding processing of the deep learning program.

In FIG. 3, a horizontal axis indicates the batch size (batch size), and a vertical axis indicates a graph of the acceleration rate (acceleration rate). As illustrated in FIG. 3, the acceleration rate increases as the batch size increases, and the acceleration rate decreases as the batch size decreases.

It is considered this is because the number of times of GPU data transfers around the epoch reduces when the batch size is larger, this reduces an overhead of GPU transfer, and GPU processing becomes more efficient. Furthermore, since a parallelism degree of the processing increases when the batch size is larger, improvement in a processing efficiency of the GPU on which a large number of arithmetic units (core) are mounted is considered as a cause.

As illustrated in FIG. 1, the scheduler 101 has the functions as the priority calculation unit 102, the calculation resource scheduling unit 103, the acceleration rate prediction unit 104, and the job history storage unit 105.

The job history storage unit 105 stores the job execution history information 107. The job execution history information 107 is information representing an execution history when a job regarding the deep learning model is executed by the user program 201. For example, the job execution history information 107 includes a batch size indicating a data amount processed by the deep learning model at a time and an execution time required to process one epoch by the calculation resource. The job execution history information 107 is an example of an execution history of a program in which the type, the batch size, and the acceleration rate of the deep learning model are associated with each other.

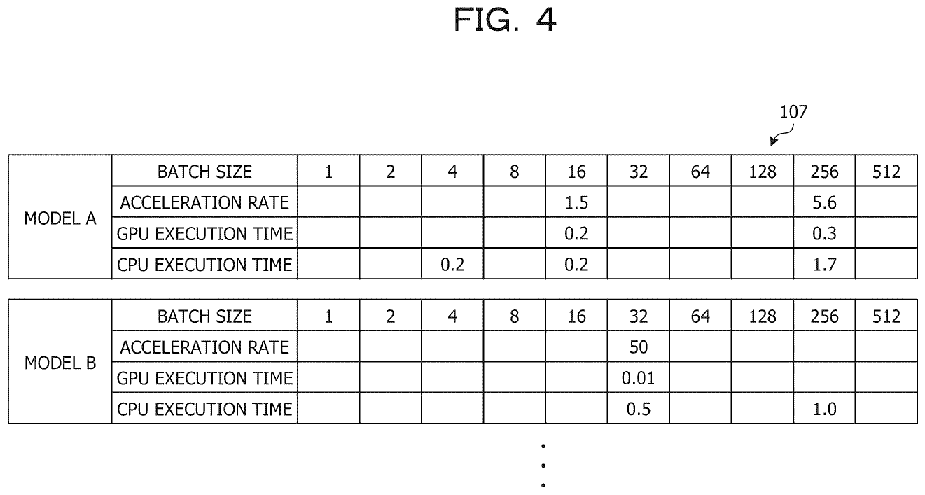

FIG. 4 is a diagram illustrating the job execution history information 107 in the scheduling system 1 according to the embodiment.

In the job execution history information 107 illustrated in FIG. 4, a plurality of types of batch sizes is indicated for each model (deep learning model), and the acceleration rate, the GPU execution time, and the CPU execution time are associated with at least some of these batch sizes. The GPU execution time is a time required to process one epoch of machine learning by the GPU 10b, and the CPU execution time is a time required to process one epoch of machine learning by the CPU 10a. The CPU execution time may be referred to as the CPU epoch execution time. Furthermore, the GPU execution time may be referred to as the GPU epoch execution time.

The GPU execution time and the CPU execution time may be measured, for example, by each user program 201 or each deep learning framework 202. A unit of the GPU execution time and the CPU execution time may be, for example, nanoseconds or microseconds.

For example, in the example illustrated in FIG. 4, regarding a model A, an acceleration rate 1.5, a GPU execution time 0.2, and a CPU execution time 0.3 are stored, for a batch size 16. This indicates a history in a case where the user program 201 executes a job with the batch size 16 regarding the deep learning model specified by the “model A” by each of the CPU 10a and the GPU 10b. In this execution history, it is indicated that a time required to process one epoch is 0.3 for the CPU 10a and is 0.2 for the GPU 10b.

Furthermore, in the job execution history information 107 illustrated in FIG. 4, the acceleration rate calculated based on the CPU execution time and the GPU execution time is illustrated. This acceleration rate is a value obtained by dividing the CPU execution time by the GPU execution time. Note that, although the acceleration rate is stored in the job execution history information 107 illustrated in FIG. 4, the embodiment is not limited to this. Only the CPU execution time and the GPU execution time may be stored in the job execution history information 107, and for example, the acceleration rate prediction unit 104 to be described later may calculate the acceleration rate as necessary.

As described above, in the job execution history information 107, information regarding the history in which the user program 201 executes the job for training the deep learning model is stored. The deep learning model recorded in the job execution history information 107 may be referred to as a past deep learning model.

The storage of the job execution history in the job execution history information 107 may be performed by the corresponding deep learning framework 202, each time when the user program 201 executes the job.

In a case where the execution history of the same batch size for the same deep learning model has already been stored in this job execution history information 107 when the deep learning framework 202 stores the job execution history in the job execution history information 107, it is desirable for the deep learning framework 202 to overwrite and update the job execution history information 107 using a new job execution history.

The acceleration rate prediction unit 104 predicts the acceleration rate of the user program 201, based on the deep learning information (deep learning model object and input tensor size (batch size)) for the user program 201 that executes the job and the job execution history information 107 stored in the job history storage unit 105. The acceleration rate prediction unit 104 determines a predicted value of the acceleration rate of the user program 201 for each job.

The acceleration rate prediction unit 104 predicts the acceleration rate accompanying the execution of the deep learning model, with reference to the job execution history information 107, based on the deep learning information (information regarding job to be processed).

First, the acceleration rate prediction unit 104 confirms whether or not the deep learning model same as the deep learning model that is the training target of the scheduling target user program 201 is stored in the job execution history information 107, by referring to the job execution history information 107 based on the deep learning model object for the scheduling target user program 201.

Therefore, the acceleration rate prediction unit 104 determines whether or not the deep learning model that is the training target of the scheduling target user program 201 and the deep learning model stored in the job execution history information 107 are the same.

For example, the acceleration rate prediction unit 104 may determine whether or not the deep learning models are the same, by comparing a plurality of types of feature amounts of the deep learning model such as a type, the number, or a size of each Layer included in the deep learning model.

The acceleration rate prediction unit 104 compares a feature amount of the deep learning model of the scheduling target user program 201 with a feature amount of the past deep learning model, and for example, in a case where the feature amounts completely match, the acceleration rate prediction unit 104 may consider that the feature amount of the deep learning model of the scheduling target user program 201 and the past deep learning model are the same.

Note that determination regarding the sameness of the deep learning model is not limited to a case where the plurality of types of feature amounts is completely the same. For example, even in a case where some of the plurality of types of feature amounts do not match, the acceleration rate prediction unit 104 may consider that the deep learning model of the scheduling target user program 201 and the past deep learning model are the same.

For example, in a case where a specific feature amount among the plurality of types of feature amounts matches, the acceleration rate prediction unit 104 may determine that the deep learning models are the same, and in a case where a predetermined number of feature amounts, among the plurality of types of feature amounts match, the acceleration rate prediction unit 104 may determine that the deep learning models are the same, and can appropriately make a change and execution.

For example, in a case where the feature amount of the deep learning model of the scheduling target user program 201 and the feature amount of the past deep learning model satisfy a predetermined similarity condition, the acceleration rate prediction unit 104 may determine that these deep learning models are the same.

In a case where it is determined that the feature amount of the deep learning model of the scheduling target user program 201 and the past deep learning model are the same, the acceleration rate prediction unit 104 compares a batch size in which the acceleration rate is stored in the job execution history information 107 regarding the deep learning model and the batch size of the scheduling target user program 201.

The acceleration rate prediction unit 104 confirms whether or not the acceleration rate is stored in a batch size same as the batch size of the scheduling target user program 201, for a deep learning model same as the deep learning model of the scheduling target user program 201, in the job execution history information 107. Hereinafter, in the job execution history information 107, the batch size in which the acceleration rate is recorded may be referred to as a batch size with an execution history.

In the example illustrated in FIG. 4, the batch sizes 16 and 256 for the model A are the batch sizes with the execution history. Furthermore, a batch size 32 for a model B is the batch size with the execution history.

In a case where the acceleration rate is stored in the batch size same as the batch size of the scheduling target user program 201 for the deep learning model of the job execution history information 107, the acceleration rate prediction unit 104 determines the acceleration rate in the batch size with the execution history as the predicted value of the acceleration rate of the scheduling target user program 201. A predicted value of the acceleration rate determined in this way may be referred to as a predicted acceleration rate.

For example, in a case where the deep learning model of the scheduling target user program 201 is the same as the model A of the job execution history information 107 illustrated in FIG. 4, in a case where the batch size of the scheduling target user program 201 is 16, the acceleration rate prediction unit 104 determines a predicted acceleration rate of the batch size 16 of the scheduling target user program 201 as 1.5.

Furthermore, in a case where the acceleration rate is not stored in the batch size same as the batch size of the scheduling target user program 201, for the deep learning model of the job execution history information 107, the acceleration rate prediction unit 104 determines a range that a value of the acceleration rate of the scheduling target user program 201 may take (predicted acceleration rate range), based on the acceleration rate of the batch size with the execution history for the same deep learning model, in the job execution history information 107.

The acceleration rate prediction unit 104 determines the predicted acceleration rate range of the acceleration rate of the scheduling target user program 201 with reference to the batch size with the execution history, according to a magnitude relationship between the batch size with the execution history for the same deep learning model in the job execution history information 107 and the batch size of the scheduling target user program 201.

For example, in a case where the deep learning model of the scheduling target user program 201 is the same as the model of the job execution history information 107 illustrated in FIG. 4, in a case where the batch size of the scheduling target user program 201 is smaller than the batch size with the execution history, the acceleration rate prediction unit 104 determines that the predicted acceleration rate range of the batch size of the scheduling target user program 201 is smaller than the acceleration rate of the batch size with the execution history.

For example, in a case where the deep learning model of the scheduling target user program 201 is the same as the model A of the job execution history information 107 illustrated in FIG. 4, in a case where the batch size of the scheduling target user program 201 is smaller than 16 (for example, eight), the acceleration rate prediction unit 104 determines that the predicted acceleration rate range of the batch size (for example, eight) of the scheduling target user program 201 is less than 1.5.

Furthermore, in a case where the batch size of the scheduling target user program 201 is larger than the batch size with the execution history, the acceleration rate prediction unit 104 determines that the predicted acceleration rate range of the batch size of the scheduling target user program 201 is larger than the acceleration rate of the batch size with the execution history.

For example, in a case where the deep learning model of the scheduling target user program 201 is the same as the model A of the job execution history information 107 illustrated in FIG. 4, in a case where the batch size of the scheduling target user program 201 is larger than 256 (for example, 512), the acceleration rate prediction unit 104 determines that the predicted acceleration rate range of the batch size (for example, 512) of the scheduling target user program 201 is larger than 5.6.

Moreover, in a case where the batch size of the scheduling target user program 201 is a value between the two batch sizes with the execution history, the acceleration rate prediction unit 104 determines that the predicted acceleration rate range of the batch size of the scheduling target user program 201 is a value between acceleration rates of the two batch sizes with the execution history.

For example, in a case where the deep learning model of the scheduling target user program 201 is the same as the model A of the job execution history information 107 illustrated in FIG. 4, in a case where the batch size of the scheduling target user program 201 is larger than 16 and less than 256 (for example, 64), the acceleration rate prediction unit 104 determines that the predicted acceleration rate range of the batch size (for example, 64) of the scheduling target user program 201 is larger than 1.5 and less than 5.6.

In this way, the acceleration rate prediction unit 104 predicts the value of the acceleration rate of the batch size (for example, 64) of the scheduling target user program 201, by reflecting the magnitude relationship between the batch size with the execution history for the same deep learning model in the job execution history information 107 and the batch size of the scheduling target user program 201 on the magnitude relationship between the acceleration rate of the batch size with the execution history and the acceleration rate of the scheduling target user program 201. This prediction is made based on the characteristics that the acceleration rate described above monotonically increases with respect to the batch size.

Furthermore, the acceleration rate prediction unit 104 confirms consistency for each job, regarding the determined (predicted) predicted acceleration rate and predicted value acceleration rate range of the batch size of the scheduling target user program 201.

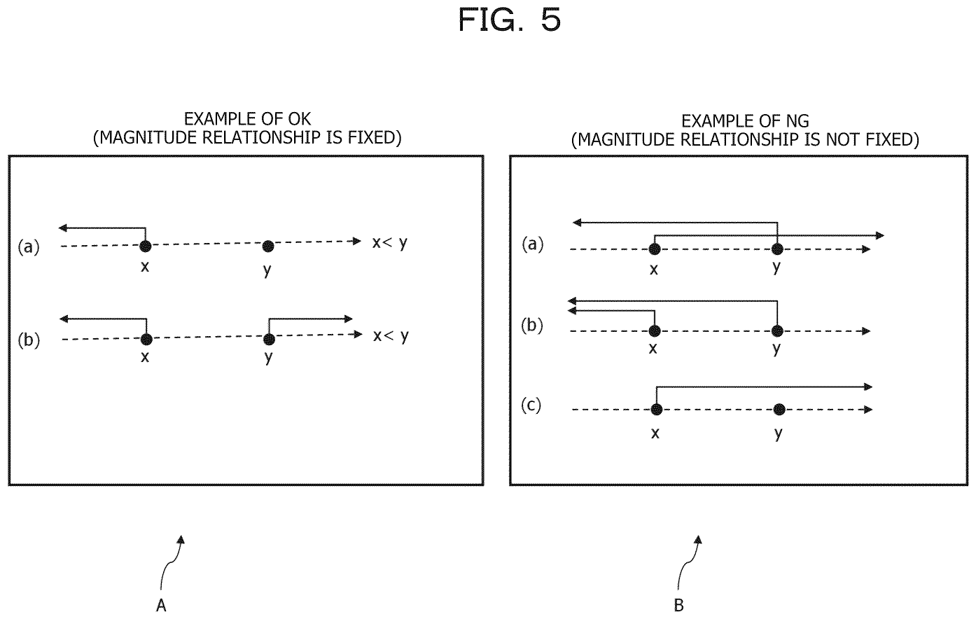

FIG. 5 is a diagram for explaining a method for verifying the predicted acceleration rate range determined by the acceleration rate prediction unit 104 of the scheduling system 1 according to the embodiment.

The acceleration rate prediction unit 104 confirms whether or not a determined predicted acceleration rate range for one job (x) and a determined acceleration rate or predicted acceleration rate range for all other jobs (y) have a relationship with consistency as described below.

Here, a predicted acceleration rate range of the job x is set as a set X, and a predicted acceleration rate (or predicted acceleration rate range) of a job y is set to a set Y. Furthermore, X∩Y=φ. The reference q represents an empty set.

In FIG. 5, a reference A indicates an example in which the determined predicted acceleration rate range for the job (x) and the determined predicted acceleration rate or predicted acceleration rate range for all the other jobs (y) have consistency.

Furthermore, (a) in the reference A indicates a relationship between the determined predicted acceleration rate range for the job (x) and the determined predicted acceleration rate for all the other jobs (y), and (b) indicates a relationship between the determined predicted acceleration rate range for the job (x) and the determined predicted acceleration rate range for all the other jobs (y).

In both of (a) and (b) of the reference A, a magnitude relationship x<y is fixed between the determined predicted acceleration rate range for the job (x) and the determined predicted acceleration rate or predicted acceleration rate range for the job (y).

On the other hand, the reference B indicates an example in which the determined predicted acceleration rate range for the job (x) and the determined predicted acceleration rate or predicted acceleration rate range for all the other jobs (y) do not have consistency.

In the reference B, each of (a) and (b) indicates a relationship between the determined predicted acceleration rate range for the job (x) and the determined predicted acceleration rate range for all the other jobs (y), and (c) indicates a relationship between the determined predicted acceleration rate range for the job (x) and the determined predicted acceleration rate for all the other jobs (y).

Any one of (a) to (c) of the reference B includes a portion of x<y and a portion of x>y. For example, in (a) to (c) of the reference B, the magnitude relationship between the determined predicted acceleration rate range for the job (x) and the determined predicted acceleration rate or predicted acceleration rate range for the job (y) is not fixed.

In a case of determining that there is consistency, as a result of confirming the consistency as described above, the acceleration rate prediction unit 104 transmits the determined (predicted) predicted acceleration rate or predicted value acceleration rate range of the batch size of the scheduling target user program 201 to the calculation resource scheduling unit 103 to be described later. In the calculation resource scheduling unit 103, the predicted acceleration rate and the predicted acceleration rate range determined by the acceleration rate prediction unit 104 are used to determine the priority of the job.

On the other hand, in a case of determining that there is no consistency, as a result of confirming the consistency as described above, the acceleration rate prediction unit 104 discards the determined (predicted) predicted acceleration rate and predicted value acceleration rate range of the batch size of the scheduling target user program 201. For a job that is determined not to have consistency in the predicted acceleration rate or the predicted value acceleration rate range, a priority is calculated by the priority calculation unit 102 to be described later.

The priority calculation unit 102 sets a priority used to determine a priority for allocating the GPU 10b to the job.

The priority calculation unit 102 may set the priority to the job using various methods. For example, the priority calculation unit 102 may set the priority according to the dummy job execution status of the job information of the job.

Before the execution of the user program 201, the priority calculation unit 102 executes the dummy job so as to measure a performance of each calculation resource. The dummy job may be a part of the job executed by the user program 201 or may be, for example, processing for one epoch of machine learning.

In a case of determining that the prediction result of the acceleration rate does not have consistency, as a result of confirming the consistency by the acceleration rate prediction unit 104, the priority calculation unit 102 calculates a priority for the job determined not to have the consistency.

The priority calculation unit 102 causes each of the CPU 10a and the GPU 10b to execute the dummy job and acquires each execution time (CPU execution time and GPU execution time). The CPU execution time and the GPU execution time may be acquired, for example, from the deep learning framework 202.

The priority calculation unit 102 calculates the acceleration rate based on the CPU execution time and the GPU execution time. The priority calculation unit 102 calculates the acceleration rate by dividing the CPU execution time by the GPU execution time.

The priority calculation unit 102 sets a job priority based on the calculated acceleration rate. For example, the priority calculation unit 102 may set the calculated acceleration rate as a value of the job priority. Furthermore, the priority calculation unit 102 notifies the calculation resource scheduling unit 103 of the set priority.

Furthermore, in a case where the dummy job execution status of the job is not CPU dummy job execution completion, the priority calculation unit 102 may set a value indicating that the GPU 10b is not allocated, to the job priority of the job. The value indicating that the GPU 10b is not allocated may be, for example, “−1”.

Moreover, in a case where the GPU dummy job execution is not completed in the dummy job execution status, the priority calculation unit 102 may set a value representing the highest priority to the job priority of the job. The value representing the highest priority may be, for example, “INT_MAX”.

Furthermore, in a case where the CPU dummy job has been executed and the GPU dummy job has been executed in the dummy job execution status, the priority calculation unit 102 may calculate the acceleration rate based on the CPU epoch execution time and the GPU epoch execution time. The priority calculation unit 102 calculates the acceleration rate by dividing the CPU execution time by the GPU execution time.

The priority calculation unit 102 notifies the calculation resource scheduling unit 103 of the set priority.

The calculation resource scheduling unit 103 schedules the job based on the priority of the job and allocates the calculation resource (GPU 10b) according to the priority of the job.

For example, the calculation resource scheduling unit 103 determines an allocation order to the calculation resource according to the priority. For example, an allocation order of a job with the highest priority to the calculation resource is set to one. Furthermore, the calculation resource scheduling unit 103 prioritizes a job having an earlier input time, regarding jobs having the same acceleration rate.

The calculation resource scheduling unit 103 determines an order of the user program 201 to be allocated to the GPU 10b (calculation resource), based on a prediction result (predicted acceleration rate and predicted acceleration rate range) of the acceleration rate.

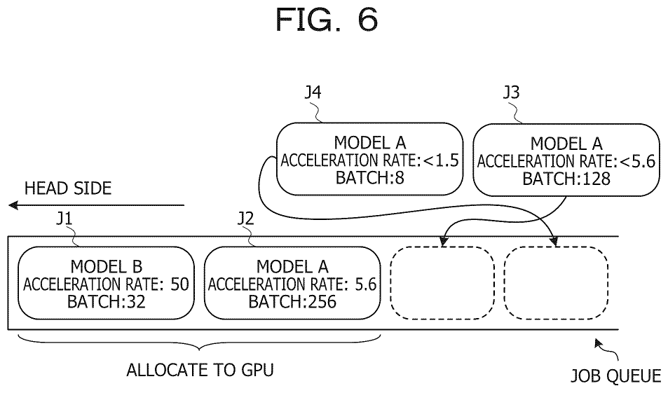

The calculation resource scheduling unit 103 arranges the jobs in a job queue 108 (refer to FIG. 6), according to the determined allocation order. In the job queue 108, a job stored on the head side is preferentially allocated to the GPU 10b. In the scheduling system 1, since the two GPUs 10b are mounted, two jobs from the head of the job queue 108 are allocated to the GPU 10b.

FIG. 6 is a diagram for explaining processing of the calculation resource scheduling unit 103 of the scheduling system 1 according to the embodiment.

In the example illustrated in FIG. 6, a case will be described where two jobs J1 and J2 are stored in the job queue 108 and jobs J3 and J4 are further allocated in this state.

The calculation resource scheduling unit 103 refers to each acceleration rate (predicted acceleration rate and predicted acceleration rate range) of the jobs J3 and J4 and determines to store the job J3 having the larger acceleration rate (predicted acceleration rate and predicted acceleration rate range) before the job J4, in the job queue 108.

Furthermore, since the predicted acceleration rate range (<5.6: less than 5.6) of the job J3 is smaller than the acceleration rate (5.6) of the job J2 stored in advance in the job queue 108, the calculation resource scheduling unit 103 stores the job J3 after the job J2, in the job queue 108.

Since the predicted acceleration rate range (<1.5: less than 1.5) of the job J4 is smaller than the predicted acceleration rate range (<5.6: less than 5.6) of the job J3, the calculation resource scheduling unit 103 stores the job J4 after the job J3, in the job queue 108.

Furthermore, the calculation resource scheduling unit 103 returns a GPU number, as the resource information, to the deep learning framework 202 of the job to which the GPU 10b is allocated.

Moreover, the calculation resource scheduling unit 103 returns a GPU number “−1”, as the resource information, to the deep learning framework 202 of the job to which the GPU 10b is not allocated or having a priority of −1. The resource information is information used to specify the calculation resource (GPU 10b and CPU 10a) used to execute the job and may be, for example, the GPU number or a CPU number.

The deep learning framework 202 updates the dummy job execution status (CPU epoch execution time or GPU epoch execution time) and transmits the resource information and the job information to the job control unit 106. Furthermore, the deep learning framework 202 saves the updated dummy job execution status (CPU epoch execution time or GPU epoch execution time) in the job execution history information 107.

Furthermore, the deep learning framework 202 transmits the resource information and the job information of the executed job, to the job control unit 106.

The job control unit 106 causes the user program 201 to execute the job, in accordance with a result of scheduling by the calculation resource scheduling unit 103.

The job control unit 106 activates the job. At the time of this activation of the job, the job control unit 106 initializes the job information of the activated job. In the job initialization, the job control unit 106 generates a job ID, and in addition, initializes the dummy job execution status.

The job control unit 106 activates the user program 201 and transmits the job information regarding the job to be executed to the user program 201.

The job control unit 106 processes one or more jobs registered in the job queue 108 in order from a head side. The job control unit 106 executes machine learning processing until an epoch ends, and stands by while machine learning processing is executed.

Furthermore, in a case where the resource information of the job executed by the user program 201 is different from the resource information of the calculation resource that is currently executing the user program 201, the job control unit 106 stops the user program 201 and re-activates the job with a new calculation resource.

### (C) Operation

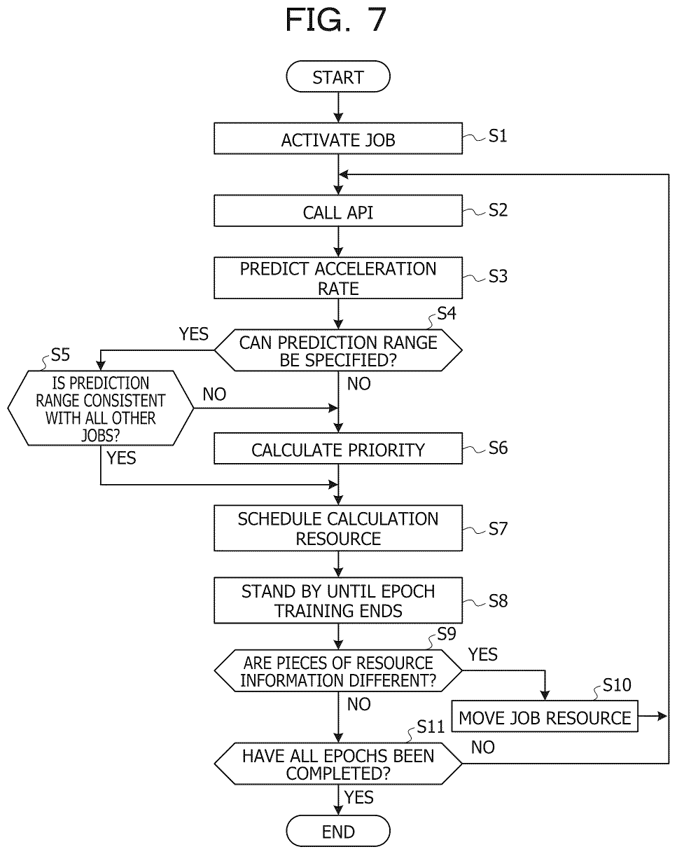

Processing for training the deep learning model in the scheduling system 1 according to the embodiment configured as described above will be described with reference to the flowchart (steps S1 to S11) illustrated in FIG. 7. The processing illustrated in FIG. 7 is repeatedly executed until all epochs in training of the deep learning model are completed.

In step S1, the job control unit 106 activates a job used to train the deep learning model. The job control unit 106 initializes job information of the activated job. Furthermore, the job control unit 106 activates the user program 201 and transmits the job information of the job to be executed to the user program 201.

In step S2, the user program 201 calls the API of the deep learning framework 202. The deep learning framework 202 executes a function for transmitting the job information and the deep learning information to the acceleration rate prediction unit 104, via the hook built in the API.

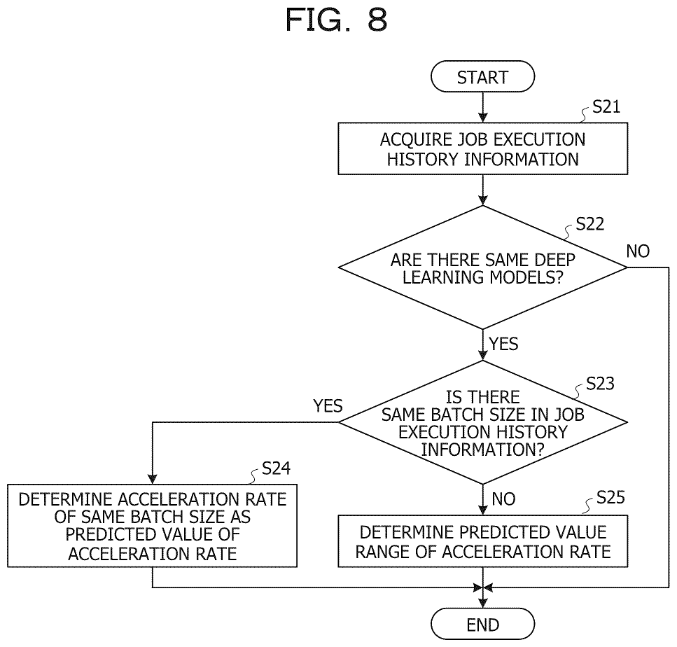

In step S3, the acceleration rate prediction unit 104 predicts an acceleration rate (predicted acceleration rate and predicted acceleration rate range) of the job. Details of the processing in step S3 will be described later with reference to FIG. 8.

In step S4, the acceleration rate prediction unit 104 confirms whether or not the deep learning model same as the deep learning model that is the training target of the scheduling target user program 201 is stored in the job execution history information 107, by referring to the job execution history information 107 based on the deep learning model object for the scheduling target user program 201.

As a result of the confirmation, in a case where the deep learning model same as the deep learning model that is the training target of the scheduling target user program 201 is not stored in the job execution history information 107, for example, in a case where it is not possible to specify a prediction range (refer to No route in step S4), the procedure proceeds to step S6.

In step S6, the priority calculation unit 102 sets a priority used to determine the priority of allocation to the GPU 10b to the job.

The priority calculation unit 102 causes each of the CPU 10a and the GPU 10b to execute the dummy job and acquires each execution time (CPU execution time and GPU execution time). The priority calculation unit 102 calculates the acceleration rate based on the CPU execution time and the GPU execution time. For example, the priority calculation unit 102 sets the calculated acceleration rate as a value of the job priority. The priority calculation unit 102 notifies the calculation resource scheduling unit 103 of the set priority. Thereafter, the procedure proceeds to step S7.

Furthermore, as a result of the confirmation in step S4, in a case where the deep learning model same as the deep learning model that is the training target of the scheduling target user program 201 is stored in the job execution history information 107, for example, in a case where the prediction range can be specified (refer to Yes route in step S4), the procedure proceeds to step S5.

In step S5, the acceleration rate prediction unit 104 confirms consistency for each job, regarding the determined (predicted) predicted acceleration rate and predicted value acceleration rate range of the batch size of the scheduling target user program 201. The acceleration rate prediction unit 104 confirms whether or not a determined predicted acceleration rate range for one job (x) and a determined acceleration rate or predicted acceleration rate range for all other jobs (y) have a relationship with consistency.

As a result of the confirmation, in a case where the determined predicted acceleration rate range for the one job (x) and the determined acceleration rate or predicted acceleration rate range for all the other jobs (y) have a relationship with no consistency (refer to No route in step S5), the procedure proceeds to step S6. As a result, the priority calculation unit 102 sets the priority for the job.

On the other hand, in a case where the determined predicted acceleration rate range for the one job (x) and the determined acceleration rate or predicted acceleration rate range for all the other jobs (y) have a relationship with consistency (refer to Yes route in step S5), the procedure proceeds to step S7.

In step S7, the calculation resource scheduling unit 103 schedules the job, based on the priority of the job. The calculation resource scheduling unit 103 allocates the calculation resource (GPU 10b and CPU 10a) based on the priority of the job.

In step S8, the job control unit 106 causes the user program 201 to execute the job, in accordance with the result of scheduling by the calculation resource scheduling unit 103. The job control unit 106 executes machine learning processing until the epoch ends and stands by before machine learning processing ends.

When machine learning processing ends, in step S9, the job control unit 106 confirms whether or not the resource information of the job executed by the user program 201 is different from the resource information of the calculation resource that is currently executing the user program 201.

As a result of the confirmation, in a case where the resource information of the job executed by the user program 201 is different from the resource information of the calculation resource that is currently executing the user program 201 (refer to Yes route in step S9), the procedure proceeds to step S10.

In step S10, the job control unit 106 moves a job resource. For example, the job control unit 106 stops the user program 201 and re-activates the job with a new calculation resource. Thereafter, the procedure returns to step S2.

Furthermore, in a case where the resource information of the job executed by the user program 201 is the same as the resource information of the calculation resource that is currently executing the user program 201 (refer to No route in step S9), the procedure proceeds to step S11.

In step S11, the job control unit 106 confirms whether or not machine learning processing of the deep learning model has been completed for all the epochs. In a case where all the epochs have not been completed (refer to No route in step S11), the procedure returns to step S2. Furthermore, in a case where all the epochs have been completed (refer to Yes route in step S11), the processing ends.

Next, the details of the processing in step S3 of the flowchart illustrated in FIG. 7 will be described with reference to the flowchart (steps S21 to S25) illustrated in FIG. 8.

In step S21, the acceleration rate prediction unit 104 acquires the job execution history information 107, by reading the job execution history information 107 from the job history storage unit 105.

In step S22, the acceleration rate prediction unit 104 confirms whether or not the deep learning model same as the deep learning model that is the training target of the scheduling target user program 201 is stored in the job execution history information 107, by referring to the job execution history information 107 based on the deep learning model object for the scheduling target user program 201.

As a result of the confirmation, in a case where the same deep learning models are stored in the job execution history information 107 (refer to Yes route in step S22), the procedure proceeds to step S23.

In step S23, the acceleration rate prediction unit 104 confirms whether or not the acceleration rate is stored in the batch size same as the batch size of the scheduling target user program 201, for the deep learning model same as the deep learning model of the scheduling target user program 201, in the job execution history information 107.

As a result of the confirmation, in a case where the acceleration rate is stored in the batch size same as the batch size of the scheduling target user program 201, for the deep learning model same as the deep learning model of the scheduling target user program 201 in the job execution history information 107 (refer to Yes route in step S23), the procedure proceeds to step S24.

In step S24, the acceleration rate prediction unit 104 determines the acceleration rate of the batch size with the execution history as the predicted value (predicted acceleration rate) of the acceleration rate of the scheduling target user program 201. Thereafter, the processing ends.

Furthermore, as a result of the confirmation in step S23, in a case where the acceleration rate is not stored in the batch size same as the batch size of the scheduling target user program 201, for the deep learning model same as the deep learning model of the scheduling target user program 201 in the job execution history information 107 (refer to No route in step S23), the procedure proceeds to step S25.

In step S25, the acceleration rate prediction unit 104 determines a range that the value of the acceleration rate of the scheduling target user program 201 may take (predicted acceleration rate range), based on the acceleration rate of the batch size with the execution history for the same deep learning model in the job execution history information 107. Thereafter, the processing ends.

Furthermore, as a result of the confirmation in step S22, in a case where the deep learning model same as the deep learning model that is the training target of the scheduling target user program 201 is not stored in the job execution history information 107 (refer to No route in step S22), the processing ends.

### (D) Effects

In this way, according to the scheduling system 1 as an example of the embodiment, the acceleration rate prediction unit 104 predicts the acceleration rate (predicted acceleration rate and predicted acceleration rate range) of the user program 201, based on the deep learning information (deep learning model object and input tensor size (batch size)) for the user program 201 that executes the job and the job execution history information 107 stored in the job history storage unit 105. Then, the calculation resource scheduling unit 103 uses the predicted acceleration rate and the predicted acceleration rate range determined by the acceleration rate prediction unit 104 to determine the priority of the job.

As a result, the priority calculation unit 102 does not need to calculate the priority of the job and does not issue the dummy job to the user program 201. Therefore, it is possible to reduce the number of unnecessary dummy executions. Therefore, execution time cost and switching cost of the calculation resources (CPU 10a and GPU 10b) can be reduced. Furthermore, as a result, it is possible to improve a system utilization rate.

Furthermore, the acceleration rate prediction unit 104 confirms consistency for each job, regarding the determined (predicted) predicted acceleration rate and predicted value acceleration rate range of the batch size of the scheduling target user program 201. In a case where the acceleration rate prediction unit 104 determines that there is no consistency, the priority calculation unit 102 calculates the priority for the job determined not to have the consistency.

As a result, the calculation resource scheduling unit 103 does not allocate the calculation resource (GPU 10b and CPU 10a) to the job using the priority with no consistency. For example, the calculation resource scheduling unit 103 schedules the job using the predicted acceleration rate or the predicted acceleration rate range that has a relationship having consistency with the acceleration rate or the predicted acceleration rate range determined for all the other jobs. Therefore, it is possible to improve reliability of job scheduling.

### (E) Others

Each configuration and each processing of the present embodiment may be selected or omitted as needed, or may be appropriately combined.

Then, the disclosed technology is not limited to the embodiment described above, and various modifications may be made and implemented in a range without departing from the gist of the present embodiment.

In the above embodiment, the computer 10 includes the two CPUs 10a. However, the embodiment is not limited to this. The number of CPUs 10a may be one or equal to or more than three.

Furthermore, in the embodiment described above, the computer 10 includes the CPU 10a as the calculation resource. However, the embodiment is not limited to this. Another processor may be included, instead of the CPU 10a. As the processor, for example, an integrated circuit (IC) such as a CPU, a micro processing unit (MPU), an accelerated processing unit (APU), a digital signal processor (DSP), an application specific IC (ASIC), or a field-programmable gate array (FPGA) is exemplified. Note that a combination of two or more of these integrated circuits may be used as the processor. The MPU is an abbreviation of a micro processing unit. The APU is an abbreviation for an accelerated processing unit. The DSP is an abbreviation for a digital signal processor, the ASIC is an abbreviation for an application specific IC, and the FPGA is an abbreviation for a field-programmable gate array.

Moreover, in the embodiment described above, the computer 10 includes the two GPUs 10b. However, the embodiment is not limited to this. The number of GPUs 10b may be one or equal to or more than three.

Furthermore, in the embodiment described above, the computer 10 includes the GPU 10b as the calculation resource. However, the embodiment is not limited to this. Another graphic processing device may be included instead of the GPU 10b. As the graphic processing device, various arithmetic processing devices, integrated circuits (IC) such as an APU, a DSP, an ASIC, or a FPGA can be exemplified.

Furthermore, those skilled in the art may carry out or manufacture the present embodiment according to the disclosure described above.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a scheduling program for causing a computer to execute processing comprising:
predicting an acceleration rate that accompanies with execution of a deep learning model, with reference to an execution history of a program in which a type, a batch size, and an acceleration rate of the deep learning model are associated, based on information regarding a job to be processed for the deep learning model; and
determining an order of a program that allocates a calculation resource, based on a prediction result of the acceleration rate.

2. The non-transitory computer-readable recording medium according to claim 1, for causing the computer to execute processing comprising:
confirming consistency for each job, regarding the prediction result of the acceleration rate; and
calculating a priority, for a job determined not to have consistency, in a case where it is determined that the prediction result of the acceleration rate does not have consistency, as a result of the consistency confirmation.

3. An information processing device comprising:
a memory; and
a processor coupled to the memory and configured to:
predict an acceleration rate that accompanies with execution of a deep learning model, with reference to an execution history of a program in which a type, a batch size, and an acceleration rate of the deep learning model are associated, based on information regarding a job to be processed for the deep learning model; and
determine an order of a program that allocates a calculation resource, based on a prediction result of the acceleration rate.

4. The information processing device according to claim 3, wherein the processor:
confirms consistency for each job, regarding the prediction result of the acceleration rate; and
calculates a priority, for a job determined not to have consistency, in a case where it is determined that the prediction result of the acceleration rate does not have consistency, as a result of the consistency confirmation.

5. A scheduling method for causing a computer to execute processing comprising:
predicting an acceleration rate that accompanies with execution of a deep learning model, with reference to an execution history of a program in which a type, a batch size, and an acceleration rate of the deep learning model are associated, based on information regarding a job to be processed for the deep learning model; and
determining an order of a program that allocates a calculation resource, based on a prediction result of the acceleration rate.

6. The scheduling method according to claim 5, for causing the computer to execute processing comprising:
confirming consistency for each job, regarding the prediction result of the acceleration rate; and
calculating a priority, for a job determined not to have consistency, in a case where it is determined that the prediction result of the acceleration rate does not have consistency, as a result of the consistency confirmation.
